(19) United States
(12) Patent Application Publication
(10) Pub. No.: US 2025/0297914 A1
(43) Pub. Date: Sep. 25, 2025

(54) METHOD AND SYSTEM FOR BUILDING CLOSED-RANGE INSPECTION

(71) Applicant: INTERNATIONAL BUSINESS MACHINES CORPORATION, Armonk, NY (US)

(72) Inventors: Ai Kiar Ang, Singapore (SG); Xinxin Huang, Singapore (SG); Christian Nugraha, Singapore (SG); Tadanobu Inoue, Yokohama (JP); Lay Him Yeo, Singapore (SG)

(21) Appl. No.: 18/610,874

(22) Filed: Mar. 20, 2024

(51) Int. Cl. G01M 5/00; B64C 39/02; B64D 47/08; G06T 7/00

(52) U.S. Cl. CPC G01M 5/0091; B64C 39/024; B64D 47/08; G01M 5/0033; G01M 5/0066; G06T 7/0004; G06T 2207/20081; G06T 2207/20084

(57) ABSTRACT

According to one embodiment, a method, computer system, and computer program product for performing a close-range inspection on a façade is provided. The present invention may include conducting a close-range inspection of inspection sites using a camera-equipped drone, wherein the close-range inspection comprises a close visual inspection and a tactile assessment; determining, by the visual AI engine, a visual building quality of the façade at the inspection sites based on images from the close visual assessment of the inspection sites; determining, by the acoustic AI engine, an acoustic building quality of the façade at the inspection sites based on impact sounds from the tactile assessment of the inspection sites; generating a digital representation of the façade based on the visual building quality and the acoustic building quality.

### BACKGROUND

The present invention relates, generally, to the field of computing, and more particularly to building inspection.

The field of building inspection may be the field concerned with surveying the structural elements of a building, and/or component systems of a building such as plumbing, electrical, or HVAC systems, to determine whether the building meets applicable standards of structural integrity. Due to the degrading effects of time, exposure to the elements, usage, various stresses, et cetera, building façades need to be regularly inspected and maintained to ensure public safety. A lack of regular inspections can result in damage to a building or harm to individuals in or around the building due to structural issues that might have been otherwise caught and corrected.

### SUMMARY

According to one embodiment, a method, computer system, and computer program product for performing a close-range inspection on a façade is provided. The present invention may include conducting a close-range inspection of inspection sites using a camera-equipped drone, wherein the close-range inspection comprises a close visual inspection and a tactile assessment; determining, by the visual AI engine, a visual building quality of the façade at the inspection sites based on images from the close visual assessment of the inspection sites; determining, by the acoustic AI engine, an acoustic building quality of the façade at the inspection sites based on impact sounds from the tactile assessment of the inspection sites; generating a digital representation of the façade based on the visual building quality and the acoustic building quality.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating a drone inspection process according to at least one embodiment;

FIG. 3 is a component diagram illustrating a drone inspection system according to at least one embodiment; and

FIG. 4 is a component diagram of a tactile assessment device according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to building inspection. The following described exemplary embodiments provide a system, method, and program product to, among other things, perform close visual inspections and tactile assessments of a building façade using a drone equipped with a camera and a tactile assessment device.

As previously described, the field of building inspection is concerned with surveying the structural elements of a building to determine whether the building meets applicable standards of structural integrity. Building condition assessments (BCA) often require a visual inspection of an external façade of a building, with a minimum percentage of the inspection to be carried out through close-range inspection. A close-range inspection may comprise a close visual inspection of the façade with tactile assessment (i.e., physical contact with the façade), carried out using probing tools (e.g. tapping rod, rubber mallet), non-destructive testing or technology (i.e., borescope, scanning equipment which does not require special training to operate or use), or a combination of the aforesaid probing tools and nondestructive testing or technology. The purpose of a close-range inspection is to observe and evaluate conditions of the façade that might be concealed or cannot be observed during the full visual inspection. Close-range inspection requires physical contact with the façade to detect both surface and underlying defects, such as delamination, de-bonding, or hollowness in plaster/tile and displacement or dislodgement of panels, failure of anchorages/fasteners/supports/brackets, as well as looseness or cracking of the elements on the building façade.

Today, close range inspection often requires inspection to be done at heights, and such inspections are typically performed manually with the use of a gondola to carry human workers up the side of the building to inspect its façade. Deployment and operation of these gondolas is laborious and dangerous, as there is a risk of fall from heights. Additionally, depending on the building configuration, the gondola may need to be relocated multiple times during the process to complete the close-range inspection. For example, a 25-story point block may require approximately eight gondola drops for a complete inspection with each gondola drop taking up to 16 work hours, including setup time. Some close-range inspection of tall buildings may be carried out using rope access inspection, wherein a human worker rappels up and down the external surface of the building to conduct the inspection. This method is also risky and time-consuming, as well as requiring a great deal of skill, expertise, and sound judgement from the user.

As such, it may be advantageous to, among other things, implement a system that conducts a full close-range inspection, including both a close visual inspection of the façade as well as a tactile assessment, using a drone equipped with purpose-built hardware coupled with AI inferencing software capable of analyzing drone data to produce an assessment of building façade quality in the form of a building quality map. Therefore, the present embodiment has the capacity to improve the technical field of building inspection by allowing building inspections to be carried out without requiring dedicated infrastructure for supporting gondolas or rope access, such as building maintenance units (BMUs) or rope attachment points, integrated into the building. Additionally, the present embodiment eliminates risk to human building inspectors, and eliminates the setup time for gondolas or top ropes, significantly reducing the risk, time, and cost required to perform close-range building inspections without compromising the accuracy or scope of the close-range inspection. Furthermore, the present embodiment of the invention creates a building quality map that provides an intuitive and comprehensive assessment of building façade quality.

References in the specification to “one embodiment,” “other embodiment,” “another embodiment,” “an embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to affect such feature, structure, or characteristic in connection with other embodiments whether or not explicitly described.

For purposes of the description hereinafter, the terms “upper”, “lower”, “right”, “left”, “vertical”, “horizontal”, “top”, “bottom”, and derivatives thereof shall relate to the disclosed structures and methods, as oriented in the drawing figures. The terms “overlying,” “atop,” “over,” “on,” “positioned on” or “positioned atop” mean that a first element is present on a second element wherein intervening elements, such as an interface structure, may be present between the first element and the second element. The term “direct contact” means that a first element and a second element are connected without any intermediary conducting, insulating, or semiconductor layers at the interface of the two elements.

In the interest of not obscuring the presentation of the embodiments of the present invention, in the following detailed description, some of the processing steps, materials, or operations that are known in the art may have been combined together for presentation and for illustration purposes and in some instances may not have been described in detail. Additionally, for brevity and maintaining a focus on distinctive features of elements of the present invention, description of previously discussed materials, processes, and structures may not be repeated with regard to subsequent Figures. In other instances, some processing steps or operations that are known may not be described. It should be understood that the following description is rather focused on the distinctive features or elements of the various embodiments of the present invention.

According to at least one embodiment, the invention is a tactile assessment device which may be an attachment for a flight-capable drone that may be enabled to extend into contact with a façade of a building, impact the façade using a solenoid knocker, and record the sounds produced by the impact using a microphone. The tactile assessment device may comprise an impact device flexibly attached to one end of a self-balancing extendable rod. The opposite end of the extendable rod may be attached to a mounting point on a drone. The impact device may comprise a solenoid knocker, a distance limiter, and a microphone, enclosed within a noise-isolating box and equipped with suspension material to isolate shock caused by contact with a surface. The impact device may be controlled by a microcontroller, which may be integrated into the impact device, attached to the arm, or integrated into the drone.

According to at least one embodiment, the invention is a method of acoustically identifying damage to a building façade by training an acoustic AI engine on an acoustic material properties corpus, receiving sounds emitted by a façade struck with a solenoid knocker, analyzing the detected sounds using the acoustic AI engine to determine building quality, and integrating the results of the analysis into a building quality map.

According to at least one embodiment, the invention is a method of visually identifying damage to a building façade by training a visual AI engine on a visual material properties corpus, receiving images of a façade from a camera-equipped drone performing a building inspection, analyzing the images using the visual AI engine to determine building quality, and integrating the results of the analysis into a building quality map.

According to at least one embodiment, the invention is a method of controlling a drone to perform a building inspection by receiving building condition assessment (BCA) parameters for a building comprising one or more façades, determining a number of close-range inspections required under the BCA parameters, identifying one or more inspection sites on the façade equivalent to the required number of close-range inspections, navigating the drone to each of the identified inspection sites to perform a close-range inspection, where the close-range inspection includes a tactile assessment and a close visual inspection, analyzing building quality using an acoustic AI engine based on the tactile assessment, analyzing building quality using a visual AI engine based on the close visual inspection, generating a building quality map representing the building quality at each inspection site, and displaying, to a user, the building quality map on a display device.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to perform close visual inspections and tactile assessments of a building façade using a drone equipped with a camera and a tactile assessment device.

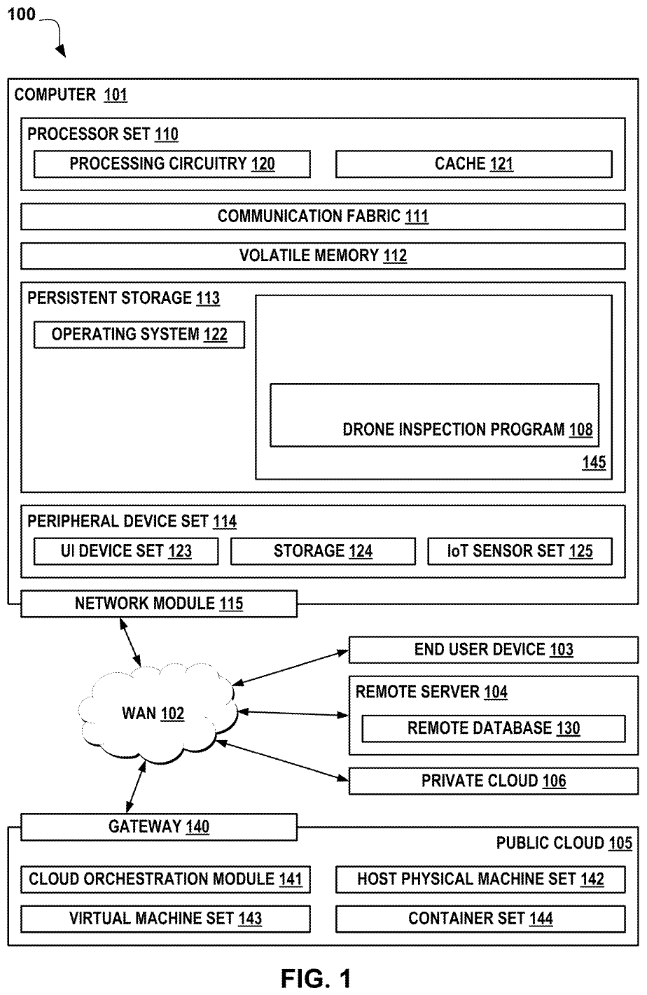

Referring now to FIG. 1, computing environment 100 contains an example of an environment for the execution of at least some of the computer code involved in performing the inventive methods, such as code block 145, which may comprise *** insert non-invention software program *** program 107 and drone inspection program 108. In addition to code block 145, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code block 145, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code block 145 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in code block 145 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

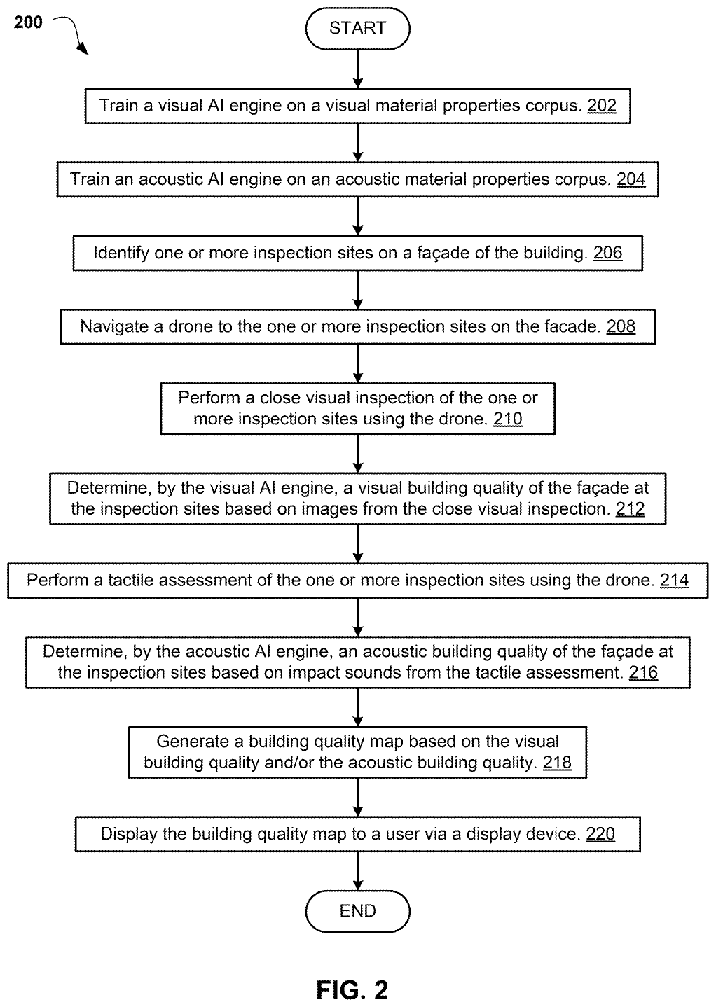

According to the present embodiment, the drone inspection program 108 may be a program enabled to perform close visual inspections and tactile assessments of a building façade using a drone equipped with a camera and a tactile assessment device. The drone inspection program 108 may, when executed, cause the computing environment 100 to carry out a drone inspection process 200. The drone inspection process 200 may be explained in further detail below with respect to FIG. 2. In embodiments of the invention, the drone inspection program 108 may be stored and/or run within or by any number or combination of devices including computer 101, end user device 103, remote server 104, private cloud 106, and/or public cloud 105, peripheral device set 114, and volatile memory 112 and/or on any other device connected to WAN 102. Furthermore, drone inspection program 108 may be distributed in its operation over any number or combination of the aforementioned devices.

Referring now to FIG. 2, an operational flowchart illustrating a drone inspection process 200 is depicted according to at least one embodiment. At 202, the drone inspection program 108 may train a visual AI engine on a visual material properties corpus. The visual AI engine may be a machine learning program that takes images of building façades taken within a threshold distance of the building façade as input and outputs a number and/or likelihood and/or severity of visible defects in the building based on detected patterns in the image. These visible defects may include defects that are visible to a close visual inspection conducted in proximity to the façade, such as delamination, de-bonding, displacement or dislodgement of panels, failure of anchorages/fasteners/supports/brackets, looseness, or cracking of elements on the façade, et cetera. The visual material properties corpus may be a corpus of images of building façades of different materials, and visual patterns that indicate particular types of damage or degradation, labeled with the materials and damage depicted, such that when provided data from the visual material properties corpus during a training phase, the visual AI engine can be trained to recognize the materials and damage in input images during the inference phase. In some embodiments, the visual material properties corpus may label training data with a severity score associated with a given defect; for example, the defect “faded paint” may be visually distinct but may be very low in severity.

At 204, the drone inspection program 108 may train an acoustic AI engine on an acoustic material properties corpus. The acoustic AI engine may be a machine learning program that takes a material of a façade and impact sounds of a solenoid knocker striking a building façade as inputs and outputs a number and/or likelihood of structural defects in the façade based on patterns in the impact sound and the material comprising the façade. These defects may include issues such as delamination, de-bonding, failure of anchorages/fasteners/supports/brackets, looseness, or cracking of elements on the façade, hollowness in plaster/tile, hollowness, or damage in wood, et cetera, which may result in a given material producing a particular sound when struck. The acoustic material properties corpus may be a corpus of impact sounds produced by building façades of different materials, and acoustic patterns that indicate particular types of damage or degradation, labeled with the materials and damage depicted, such that when provided data from the acoustic material properties corpus during a training phase, the visual AI engine can be trained to accurately recognize the presence and particular types of damage in materials based on impact sounds during the inference phase. In some embodiments, the acoustic material properties corpus may label training data with a severity score associated with a given defect; for example, the defect “hollow” in wood may indicate termites and may be very high in severity.

At 206, the drone inspection program 108 may identify one or more inspection sites on a façade of the building. Here, the drone inspection program 108 may identify one or more locations on the façade of a building where a close-range inspection must be conducted. In embodiments, the drone inspection program 108 may receive the inspection sites from a user and/or from an external service or program. In embodiments, the drone inspection program 108 may identify the inspection sites automatically by consulting building condition assessment (BCA) parameters for a building; the BCA parameters may be instructions from applicable building inspection authorities on how to conduct a close-range building inspection. The drone inspection program 108 may receive the BCA parameters from a user or from an external source. The drone inspection program 108 may determine a number of close-range inspections required under the BCA parameters and may identify one or more inspection sites on the façade equivalent to at least the required number of close-range inspections. The drone inspection program 108 may choose inspection sites randomly, and/or may analyze an image of the façade to be inspected and choose inspection sites where the visual AI engine identifies potential defects, based on features of the façade, based on wind conditions generated or occurring around features of the façade, based on distance from each other to spread inspection sites out evenly, et cetera.

At 208, the drone inspection program 108 may navigate a drone to the one or more inspection sites on the façade. In embodiments, the drone inspection program 108 may merely guide a user to operate the drone, for example by displaying the current inspection site and/or all inspection sites superimposed over an image of the façade. In embodiments, for example where the drone inspection program 108 comprises a drone control module, the drone inspection program 108 may autonomously operate the drone to move to the next inspection point and/or to operate the camera to perform the visual assessment and/or to operate the tactile assessment device to conduct the tactile assessment.

At 210, the drone inspection program 108 may perform a close visual inspection of the one or more inspection sites using the drone. Here, the drone inspection program 108 may instruct or operate the drone to move within a threshold distance of the inspection site and/or to take pictures within a particular zoom level and/or within a particular image fidelity, so as to produce images of sufficient detail to serve as inputs for the visual AI engine. The threshold distance of the inspection site may be, for example, one meter. The threshold distance may be dynamically calculated based on an image quality of the camera, such that the better the image quality of the camera, the farther the distance from the inspection site the close visual inspection may be performed. However, in embodiments, the threshold distance may not exceed an upper limit, such as three meters.

At 212, the drone inspection program 108 may determine, by the visual AI engine, a visual building quality of the façade at the inspection sites based on images from the close visual inspection. Here, the drone inspection program 108 may provide the images taken during the close visual inspection to the visual AI engine as inputs and receive as outputs a number and/or likelihood of defects present in the images. The drone inspection program 108 may assess a visual building quality based on the number, severity, and/or likelihood of defects present in the images, where the visual building quality may be a score based on a number, likelihood, and/or severity of the defects. The drone inspection program 108 may transmit the images to the visual AI engine in real time or near-real-time as the images are taken, and may upload the results of the analysis by the visual AI engine to the building quality map or to any other user-accessible device in real-time or near-real-time as the results are generated, such that close visual inspection results can be immediately accessed as the close visual inspection is completed.

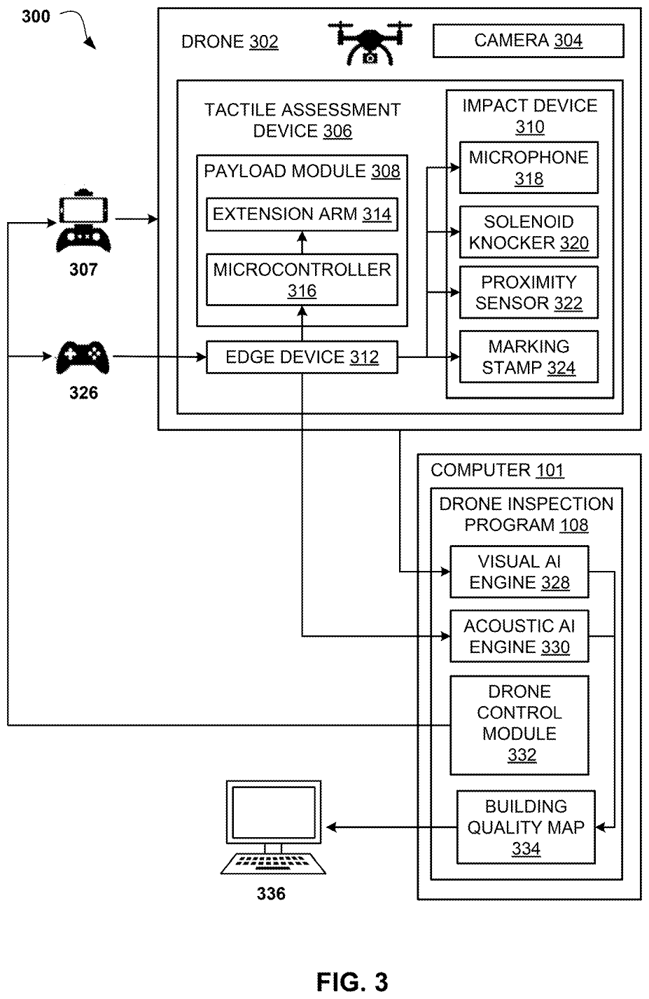

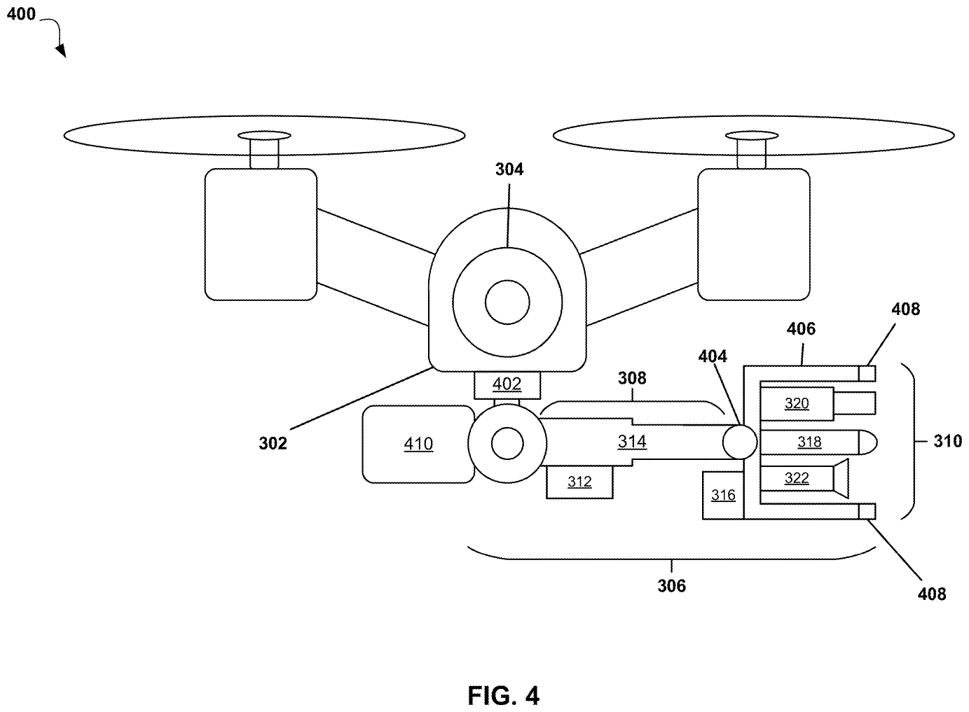

At 214, the drone inspection program 108 may perform a tactile assessment of the one or more inspection sites using the drone. The tactile assessment may be a means of assessing the structural state of a façade by non-destructively interacting with the façade to uncover defects that might not be detectable to a mere visual inspection, namely by gauging the sounds produced by a light impact against the façade; cracks, loose structural elements, hollow areas, and other defects may cause telltale modifications to the resulting sound. Here, the drone inspection program 108 may conduct a tactile assessment using a drone equipped with a tactile assessment device, both of which may be described in greater detail below with respect to FIGS. 3 and 4. The drone inspection program may instruct or operate the drone to hover at the inspection site at a pre-determined distance from the façade which may be commensurate with the extended length of an extension arm comprising the tactile assessment device and which may be determined based on sensor data from a camera or a proximity sensor. Once the drone is in position and is hovering, drone inspection program 108 may extend the extension arm beyond the reach of the drone's rotors, potentially extending a counterweight in the opposite direction to counterbalance the extension arm and maintain level flight, and place the open face of an impact device against the façade; the drone inspection program 108 may then operate a solenoid knocker comprising the impact device to strike the façade and produce impact sounds that are recorded by a microphone. The drone inspection program 108 may repeat the step of operating the solenoid knocker to strike the façade until drone inspection program 108 has successfully recorded a threshold number of impact sounds, and/or has recorded a threshold number of impact sounds that exceed a threshold level of quality. Once the threshold number of impact sounds has been recorded, the drone inspection program 108 may operate the drone to withdraw the extension arm, withdraw any counterweight, and move to the next task, be that conducting a close visual inspection at the inspection site, moving to the next inspection site, et cetera.

At 216, the drone inspection program 108 may determine, by the acoustic AI engine, an acoustic building quality of the façade at the inspection sites based on impact sounds from the tactile assessment. Here, the drone inspection program 108 may provide the impact sounds recorded during the tactile assessment to the acoustic AI engine as inputs and receive as outputs a number and/or likelihood of defects present in the provided impact sounds. The drone inspection program 108 may assess an acoustic building quality based on the number, severity, and/or likelihood of defects present in the impact sounds, where the acoustic building quality may be a score based on a number, likelihood, and/or severity of the defects at the inspection site. The drone inspection program 108 may transmit the impact sounds to the acoustic AI engine in real time or near-real-time as the impact sounds are recorded, and may upload the results of the analysis by the acoustic AI engine to the building quality map or to any other user-accessible device in real-time or near-real-time as the results are generated, such that tactile assessment results can be immediately accessed as the tactile assessment is completed.

At 218, the drone inspection program 108 may generate a building quality map based on the visual building quality and/or the acoustic building quality. Here, the drone inspection program 108 may generate a three-dimensional representation of the façade based on images of the building. The drone inspection program 108 may indicate the inspection sites, and may differentiate between inspection sites where a close range inspection has been conducted, inspection sites where only a close visual inspection has been conducted, inspection sites where only a tactile assessment has been conducted, and/or inspection sites where no close visual inspection or tactile assessment have been conducted. The drone inspection program 108 may update the quality map dynamically as new information comes in and/or as tactile assessments and/or close visual inspections have been completed. The building quality map may track and display the location of drones as they conduct the close-range inspection.

The drone inspection program 108 may generate a site quality for each inspection site, representing the building quality at each site. The site quality may be a single composite score comprising a combination of the visual building quality and the acoustic building quality available for the inspection site, representing the number, likelihood, and/or severity of the defects detected at that inspection site. The site quality may additionally or alternatively comprise a list of all defects detected in the impact sounds and/or images of the site above a threshold level of likelihood. Each inspection site may be color coded on the building quality map based on the score, where red indicates a high score, representing a high number, likelihood, and/or severity of defects at the inspection site, and green represents no defects or very few, unlikely, and/or mild defects at the inspection site. In embodiments, the drone inspection program 108 may represent all façades of a building in the building quality map and may assign a cumulative building score to the entire building based on the aggregated site scores of all inspection sites on the building. The drone inspection program 108 may color code the building itself based on the cumulative building score.

At 220, the drone inspection program 108 may display the building quality map to a user via a display device. Here, the drone inspection program 108 may display the building quality map to a user on a display device, such as a computer monitor, tablet, or smartphone screen, et cetera. The building quality map may be interactable, such that a user would be able to rotate, zoom, and mouse over the displayed building quality map, and/or click or otherwise interact with inspection sites for more information, such as the status of ongoing inspections, potential defects found at the inspection site, site score, et cetera.

Referring now to FIG. 3, a component diagram illustrating a drone inspection system 300 is depicted according to at least one embodiment. The system 300 comprises a drone 302, which may be an autonomous or remotely piloted unmanned aircraft capable of hovering in one place. The drone 302 comprises a camera 304, which may be integrated into the body of the drone 302 or may be externally mounted. The drone 302 additionally comprises a tactile assessment device 306, which may be a device for conducting a tactile assessment of a building façade, and which may likewise be integrated into the body of drone 302 or may be mounted on or affixed to a stable mounting point on the drone. The drone 302 may be flown and otherwise controlled through commands transmitted from a drone controller 307, although in embodiments, edge device 312 or payload controller 326 may additionally or alternatively be responsible for the drone 302's flight and navigation. Drone controller 307 may be a device capable of transmitting commands to drone 302 through, for example, radio frequencies, and may receive commands from drone inspection program 108, or, in embodiments where the drone controller 307 comprises a handheld remote control, from a human user operating the drone controller 307. The tactile assessment device 306 comprises a payload module 308, an impact device 310, and an edge device 312. The payload module 308 comprises an extension arm 314, which may be a mechanical armature capable of extending beyond the span of the drone 302's rotors, so as to safely place the impact device 310 against the surface of the façade without bringing the drone 302's rotors into contact with the façade as well. The extension arm 314 may extend through any number of means, including telescoping, unfolding, et cetera. The payload module 308 may further comprise a microcontroller 316, which serves to control the extension arm 314. The impact device 310 may comprise a microphone 318, a solenoid knocker 320, a proximity sensor 322, and a marking stamp 324. The marking stamp 324 may be a device capable of leaving a temporary mark on the façade when the impact device 310 is placed against the façade, to indicate that a tactile assessment was performed at the location of the mark. The marking stamp 324 may comprise a marker, felt-tip pen, chalk, et cetera capable of leaving a visible mark on a façade. The edge device 312 may comprise a small computing device such as computer 101, which may be attached to the payload module 308, the drone 302, or the impact device 310, and which serves to receive commands from payload controller 326 and relay commands to the microcontroller 316 and the components of impact device 310, as well as to relay data from the microphone 318 to drone inspection program 108. Payload controller 307 may be a device capable of transmitting commands to the tactile assessment device 306 through, for example, radio frequencies, and may receive commands from drone inspection program 108, or, in embodiments where the payload controller 326 comprises a handheld remote control, from a human user operating the payload controller 326. In embodiments, drone controller 307 and payload controller 326 may be the same device. The drone 302 and the tactile assessment device 306 are explained in greater detail below with respect to FIG. 4.

Drone inspection program 108 is herein depicted as being run on computer 101, and comprises a visual AI engine 328, an acoustic AI engine 330, a drone control module 332, and a building quality map 334. The visual AI engine 328 receives images from the drone 302 taken by the camera 304; in embodiments, the visual AI engine 328 may be understood to receive the images from an integrated long-range communications technologies such as radio and/or by short-range communications technologies system such as Wi-Fi, Bluetooth, et cetera, for example at the drone controller 307, or from edge device 312. The visual AI engine 328 may then analyze the images and output the results of the analysis to the building quality map 334. The acoustic AI engine 330 may receive impact sounds from microphone 318 via edge device 312 and may analyze these impact sounds and output the results of the analysis to the building quality map 334. The drone inspection program 108 may display the building quality map 334 on a display 336, which may be a computer monitor or screen comprising UI device set 123.

The drone control module 332 may be a program, subroutine, functionality, or other component comprising drone inspection program 108 that issues commands to drone controller 307 and/or payload controller 326 to operate the drone 302 and/or the tactile assessment device 306. The drone control module 332 may be capable of flying and navigating the drone, for example to particular inspection sites at particular altitudes and coordinates. In some embodiments of the invention, the functions of drone control module 332 may be performed by users, and/or by separate programs, cloud services, et cetera.

Referring now to FIG. 4, a component diagram illustrating a drone inspection system 400 is depicted according to at least one embodiment. Here, a drone 302 is depicted, comprising a camera 304 and a mounting point 402; affixed to mounting point 402 is tactile assessment device 306, which comprises a payload module 308 which in turn comprises an edge device 312 attached to an extension arm 314, which comprises a servomotor which allows the extension arm 314 to extend and retract on command. The extension arm 314 is affixed at one end to the mounting point 402, and at the other is attached to the impact device 310 via a flexible mounting 404; flexible mounting 404 allows the impact device 310 to orient flat against a surface of a building, even if the extension arm 314 is not perpendicular to the building, and reduces the amount of shock transferred to the drone 302 through the extension arm 314 during contact with the façade and during operation of the solenoid knocker 320. The impact device 310 comprises a solenoid knocker 320, which is comprised of a coil of wire, a housing, and a moveable plunger (armature) within the coil of wire; the plunger rapidly extends to strike a surface when an electrical current is introduced into the coil of wire. The impact device 310 further comprises a microphone 318, which may be configured in its sensitivity to record the sounds of the solenoid knocker 320 striking a façade of a building. The impact device additionally comprises a proximity sensor 322, which may be, for example, an optical, ultrasonic, or even a simple contact-based sensor that sends a signal when the proximity sensor 322 is within a threshold distance of a surface or object. The drone inspection program 108 may utilize the proximity sensor 322 to determine that the impact device 310 has made contact with a façade and may control the length of the extension arm 314 based on feedback from proximity sensor 322. Solenoid knocker 320, microphone 318, and proximity sensor 322 may all be disposed within a box 406, which may be made of sound-dampening materials to isolate the microphone 318 from all exterior sounds, including those made by drone 302, such that the microphone 318 will be better able to isolate impact sounds resulting from strikes performed by the solenoid knocker 320, and to improve the quality of the recording. Sound-insulated box 406 may be open on the face opposite the face to which the extension arm 314 is attached via flexible mounting 404, so that the solenoid knocker 320 can reach the façade, and so that microphone 318 is not isolated from the impact sounds produced by the solenoid knocker 320. The outer rim or boundary 408 of box 406 may be covered with a layer of soft material such as rubber to protect the rim 408 from abrasion from contact with the façade as well as to better seal against the façade to seal external noise out and impact sounds in. Microcontroller 316 is here attached to the exterior of the box 406 and may be wired to edge device 312 or may communicate wirelessly. In embodiments, the opposite end of the extension arm 314 from the impact device 310 may be equipped with a counterweight 410 to maintain the stability of the drone 302. The counterweight 410 may, in embodiments, be mounted on an extension arm of its own so it can be extended in the opposite direction of the impact device 310 to dynamically correct the load imbalance caused by the shifting center of gravity.

It may be appreciated that FIGS. 2-4 provide only illustrations of individual implementations and do not imply any limitations with regard to how different embodiments may be implemented. Many modifications to the depicted environments may be made based on design and implementation requirements. For example, one skilled in the art would understand embodiments of the invention to encompass only a close visual inspection or a close acoustic inspection, for example in scenarios where a close-range inspection only requires one or the other but not both.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for performing a close-range inspection on a façade, the method comprising:
conducting, using a camera-equipped drone, a close-range inspection of one or more inspection sites comprising the façade, wherein the close-range inspection comprises a close visual inspection and a tactile assessment;
determining, by a visual AI engine, a visual building quality of the façade at the one or more inspection sites based on one or more images from the close visual assessment of the one or more inspection sites;
determining, by an acoustic AI engine, an acoustic building quality of the façade at the one or more inspection sites based on one or more impact sounds from the tactile assessment of the one or more inspection sites;
generating a digital representation of the façade based on the visual building quality and the acoustic building quality.

2. The method of claim 1, wherein the tactile assessment comprises:
operating a drone-mounted tactile assessment device to extend an extension arm from the drone to place an impact device against a surface of the inspection site based on proximity data from a proximity sensor;
operating a solenoid knocker to strike the surface at least once; and
recording, by a microphone, the one or more impact sounds generated from the striking.

3. The method of claim 2, wherein the tactile assessment device comprises an edge device, a microcontroller, and the extension arm, the extension arm affixed at a first end to a mounting point on a drone, and affixed at a second end to the impact device by means of a flexible joint, wherein the impact device comprises a sound-insulated box open on a side opposing the extension arm, within which are disposed at least the solenoid knocker, the microphone, and the proximity sensor.

4. The method of claim 1, further comprising:
automatically identifying the one or more inspection sites based on at least one image of the façade and one or more received building condition assessment (BCA) parameters.

5. The method of claim 1, further comprising:
autonomously navigating the camera-equipped drone to the one or more inspection sites.

6. The method of claim 1, wherein the digital representation of the façade is updated in real-time as the tactile assessment or the close visual inspection is completed.

7. The method of claim 1, further comprising:
training a visual AI engine on a visual material properties corpus; and
training an acoustic AI engine on an acoustic material properties corpus.

8. A computer system for performing a close-range inspection on a façade, the computer system comprising:
one or more camera-equipped drones, one or more tactile assessment devices, one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
conducting, using the camera-equipped drone, a close-range inspection of one or more inspection sites comprising the façade, wherein the close-range inspection comprises a close visual inspection and a tactile assessment;
determining, by a visual AI engine, a visual building quality of the façade at the one or more inspection sites based on one or more images from the close visual assessment of the one or more inspection sites;
determining, by an acoustic AI engine, an acoustic building quality of the façade at the one or more inspection sites based on one or more impact sounds from the tactile assessment of the one or more inspection sites; and
generating a digital representation of the façade based on the visual building quality and the acoustic building quality.

9. The computer system of claim 8, wherein the tactile assessment comprises:
operating the tactile assessment device to extend an extension arm from the drone to place an impact device against a surface of the inspection site based on proximity data from a proximity sensor;
operating a solenoid knocker to strike the surface at least once; and
recording, by a microphone, the one or more impact sounds generated from the striking.

10. The computer system of claim 9, wherein the tactile assessment device comprises an edge device, a microcontroller, and the extension arm, the extension arm affixed at a first end to a mounting point on a drone, and affixed at a second end to the impact device by means of a flexible joint, wherein the impact device comprises a sound-insulated box open on a side opposing the extension arm, within which are disposed at least the solenoid knocker, the microphone, and the proximity sensor.

11. The computer system of claim 8, further comprising:
automatically identifying the one or more inspection sites based on at least one image of the façade and one or more received building condition assessment (BCA) parameters.

12. The computer system of claim 8, further comprising:
autonomously navigating the camera-equipped drone to the one or more inspection sites.

13. The computer system of claim 8, wherein the digital representation of the façade is updated in real-time as the tactile assessment or the close visual inspection is completed.

14. The computer system of claim 8, further comprising:
training a visual AI engine on a visual material properties corpus; and
training an acoustic AI engine on an acoustic material properties corpus.

15. A computer program product for performing a close-range inspection on a façade, the computer program product comprising:
one or more computer-readable tangible storage medium and program instructions stored on at least one of the one or more tangible storage medium, the program instructions executable by a processor to cause the processor to perform a method comprising:
conducting, using a camera-equipped drone, a close-range inspection of one or more inspection sites comprising the façade, wherein the close-range inspection comprises a close visual inspection and a tactile assessment;
determining, by the visual AI engine, a visual building quality of the façade at the one or more inspection sites based on one or more images from the close visual assessment of the one or more inspection sites;
determining, by the acoustic AI engine, an acoustic building quality of the façade at the one or more inspection sites based on one or more impact sounds from the tactile assessment of the one or more inspection sites; and
generating a digital representation of the façade based on the visual building quality and the acoustic building quality.

16. The computer program product of claim 15, wherein the tactile assessment comprises:
operating a drone-mounted tactile assessment device to extend an extension arm from the drone to place an impact device against a surface of the inspection site based on proximity data from a proximity sensor;
operating a solenoid knocker to strike the surface at least once; and
recording the one or more impact sounds generated from the striking.

17. The computer program product of claim 16, wherein the tactile assessment device comprises an edge device, a microcontroller, and the extension arm, the extension arm affixed at a first end to a mounting point on a drone, and affixed at a second end to the impact device by means of a flexible joint, wherein the impact device comprises a sound-insulated box open on a side opposing the extension arm, within which are disposed at least the solenoid knocker, the microphone, and the proximity sensor.

18. The computer program product of claim 15, further comprising:
automatically identifying the one or more inspection sites based on at least one image of the façade and one or more received building condition assessment (BCA) parameters.

19. The computer program product of claim 15, further comprising:
autonomously navigating the camera-equipped drone to the one or more inspection sites.

20. The computer program product of claim 15, wherein the digital representation of the façade is updated in real-time as the tactile assessment or the close visual inspection is completed.
